(19) United States
(12) Patent Application Publication
(10) Pub. No.: US 2025/0373977 A1
(43) Pub. Date: Dec. 4, 2025

(54) SPEAKER DEVICE

(71) Applicant: LG ELECTRONICS INC., Seoul (KR)

(72) Inventors: Myounghoon KWAK, Seoul (KR); Junghan RYU, Seoul (KR); Changho CHOI, Seoul (KR); Hyunggon RYU, Seoul (KR); Juyoung CHOI, Seoul (KR); Hyunki KIM, Seoul (KR); Minkyu OH, Seoul (KR); Youngwook SOHN, Seoul (KR); Sung Gul HWANG, Seoul (KR)

(73) Assignee: LG ELECTRONICS INC., Seoul (KR)

(21) Appl. No.: 18/959,372

(22) Filed: Nov. 25, 2024

(30) Foreign Application Priority Data
May 31, 2024 (WO) PCT/KR2024/007473

(51) Int. Cl. H04R 1/34; F21V 3/02; F21V 33/00; F21Y 115/10; H04R 1/02

(52) U.S. Cl. CPC H04R 1/345; F21V 3/02; F21V 33/0056; H04R 1/025; F21Y 2115/10; H04R 2201/025

(57) ABSTRACT

A speaker device is disclosed. The speaker device may allow at least one speaker unit (specifically, a speaker unit located at the bottom) of a plurality of speaker units to be tilted to be directed toward a user's face when mounted in a vertical direction, and to return to its original angle when mounted in a horizontal direction, without a separate actuator or an external force from the user. The speaker device according to an exemplary embodiment of the present disclosure may include a device housing and a plurality of speaker assemblies.

### CROSS-REFERENCE TO RELATED APPLICATION

Pursuant to 35 U.S.C. § 119, this application claims the benefit of the earlier filing date and the right of priority to PCT Patent Application No. PCT/KR2024/007473, filed on May 31, 2024, the contents of which are incorporated by reference herein in its entirety.

### BACKGROUND

### Field

The present disclosure relates to a speaker device.

### Description of the Related Art

In general, a housing of a speaker device, which is an audio device, is disposed such that a length in one direction (e.g., horizontal direction) is greater than that in another direction (e.g., vertical direction). The housing constitutes an exterior of the speaker device, and is also referred to as a “case.”

Two or more speaker units are disposed in one direction (e.g., horizontal direction) in the housing of the speaker device. The two or more speaker units may typically include a tweeter speaker, a mid-range speaker, and a woofer or mid-woofer.

The housing of the speaker device may be mounted either horizontally or vertically.

When the housing of the speaker device is mounted vertically, two or more speaker units are disposed in a row in a vertical direction. In this case, a speaker unit disposed at a bottom of the housing of the speaker device may not be directed toward a user's face.

That is, when the speaker device is mounted vertically, a radiation angle of the speaker unit disposed at the bottom of the housing of the speaker device may not be directed toward the user's face.

In order to solve this problem, in a conventional speaker device, when the housing is placed in a vertical direction, an entire speaker device is tilted by a separate actuator. Since speaker units located at the top of speaker device, which do not need to be tilted, are also tilted, the speaker units located at the top are not directed toward the user's face, or a separate actuator must be provided, and thus there is a problem in that a mechanism of the actuator becomes complicated and the manufacturing cost increases.

Therefore, a speaker device is required in which, when the speaker device is mounted in a vertical direction, only a speaker unit located at the bottom is tilted without any external force from the user with no separate actuator being provided, and when the speaker device is mounted in a horizontal direction, the tilted speaker unit is returned to its original angle.

### SUMMARY

An aspect of the present disclosure is to provide a speaker device in which, when the speaker device is mounted in a vertical direction, at least one speaker unit (e.g., a speaker unit located at the bottom) of a plurality of speaker units is tilted toward a user's face without any external force from the user with no separate actuator being provided, and when the speaker device is mounted in a horizontal direction, the tilted speaker unit is returned to its original angle.

The foregoing aspect of the present disclosure may be achieved through the following detailed description.

A speaker device according to an exemplary embodiment of the present disclosure may be mounted either in a horizontal or vertical direction, and may include a device housing and a plurality of speaker assemblies. The device housing may constitute an exterior, and the plurality of speaker assemblies may be disposed in the device housing. When mounted in the vertical direction, at least one speaker assembly of the plurality of speaker assemblies may be tilted by a load. Furthermore, when mounted in the horizontal direction, the tilted speaker assembly may be returned to its original position by a restoring force of an elastic member.

Specifically, the device housing may include a plurality of opening portions. A plurality of rotation shaft insertion holes may be disposed on an inner surface of the device housing surrounding the opening portions. When mounted in the vertical direction, the plurality of rotation shaft insertion holes may be respectively disposed on one side and the other side in a horizontal direction on an inner surface of the device housing surrounding the opening portions. A rotation shaft member of the speaker assembly may be disposed in the rotation shaft insertion hole.

Specifically, when mounted in a horizontal direction, the plurality of rotation shaft insertion holes may be respectively disposed on one side and the other side in a vertical direction on an inner surface of the device housing surrounding the opening portions.

Specifically, at least one speaker assembly of the plurality of speaker assemblies may include a speaker housing, a speaker unit, and a mass member. The speaker unit may be accommodated on one side of the speaker housing in one direction. The mass member may be accommodated on the other side of the speaker housing in the one direction and disposed to be spaced apart by a preset distance from the speaker unit in the one direction. Furthermore, a weight of the mass member may be greater than that of the speaker unit.

Specifically, the speaker housing may include a housing body, a first receiving portion, a second receiving portion, and a plurality of rotation shaft members. The first receiving portion may be disposed in the housing body to receive the speaker unit. Furthermore, the second receiving portion may be disposed in the housing body to receive the mass member. The plurality of rotation shaft members may be disposed on an outer surface of the housing body disposed with the first receiving portion.

Specifically, when mounted in the vertical direction, the housing body may be tilted in one rotation direction with the rotation shaft member as a rotation axis due to a weight of the mass member, such that the mass member moves downward and the speaker unit moves upward.

Specifically, at least one speaker assembly of the plurality of speaker assemblies may further include an elastic member. The elastic member may be a torsion spring.

Specifically, one end portion of the elastic member may be fixed to the housing body or the rotation shaft member, and the other end of the elastic member may be fixed to the rotation shaft insertion hole or the inner surface of the device housing surrounding the opening portion.

A speaker device according to an exemplary embodiment of the present disclosure may further include a light assembly. The light assembly may be disposed in a light receiving portion of the device housing. The light receiving portion may be disposed in a recess shape at one edge or the other edge of the device housing.

Specifically, the light assembly may include a cover member, a diffusion member, a substrate member, and an LED member. The cover member may allow light to pass therethrough. The diffusion member may be disposed on an inner surface of the cover member. The substrate member may be disposed on bottom and side surfaces of the light receiving portion. The LED member may be disposed on the substrate member.

Specifically, the bottom or side surface of the light receiving portion may be disposed to have a different height or different preset angle for each region.

Specifically, one surface of the substrate member may be disposed to have a different height or different preset angle for each region.

Specifically, the LED member may be disposed to have a different height or different preset angle for each region on one surface of the substrate member.

Specifically, at least one speaker assembly of the plurality of speaker assemblies may be a speaker assembly disposed at the bottom.

A speaker device according to an exemplary embodiment of the present disclosure has an effect in which, when a device housing of the speaker device is mounted in a vertical direction, at least one speaker unit (e.g., a speaker unit located at the bottom) of a plurality of speaker units is tilted toward a user's face without a separate actuator and an external force from the user.

Furthermore, a speaker device according to an exemplary embodiment of the present disclosure has an effect in which, when a housing of the speaker device is mounted in a horizontal direction, a speaker unit that has been tilted when mounted in a vertical direction is returned to its original angle without a separate actuator or an external force from the user.

In addition, a speaker device according to an exemplary embodiment of the present disclosure is provided with a light assembly, and has an effect of transmitting a uniform amount of light to a diffusion member using a reflection angle.

More detailed effects of the speaker device of the present disclosure will be described below in the Detailed Description section.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 shows a view in which a speaker device according to an exemplary embodiment of the present disclosure is disposed horizontally;

FIG. 2 shows a view in which the speaker device shown in FIG. 1 is disposed vertically;

FIG. 3 shows a view in which a speaker assembly disposed at a bottom of the speaker device shown in FIG. 2 is separated therefrom;

FIG. 4 is an exploded perspective view of the speaker assembly shown in FIG. 3;

FIG. 5 is a cross-sectional view of the speaker assembly shown in FIG. 3;

FIG. 6 shows a lower portion of a device housing in the speaker device shown in FIG. 3;

FIG. 7 is a front view of one side of the speaker device shown in FIG. 1;

FIG. 8 is a cross-sectional view taken along line A-A of FIG. 7;

FIG. 9 is a cross-sectional view taken along line B-B of FIG. 7;

FIG. 10 shows a state in which the speaker assembly disposed at a bottom of the speaker device shown in FIG. 2 is rotated;

FIG. 11 is a cross-sectional view of the speaker assembly disposed at the bottom shown in FIG. 10;

FIG. 12 shows light emitted from a light assembly of the speaker device shown in FIG. 1; and

FIG. 13 is a perspective view and a cross-sectional view showing a portion of the light assembly shown in FIG. 12.

### DETAILED DESCRIPTION OF THE EMBODIMENTS

Hereinafter, exemplary embodiments of the present disclosure will be described in more detail with reference to the accompanying drawings. Among the elements of the present disclosure, detailed descriptions of those that can be clearly understood and easily reproduced by those skilled in the art according to the prior art will be omitted so as not to obscure the subject matter of the present disclosure.

The accompanying drawings are merely illustrated to help easily understand the exemplary embodiments disclosed in this specification, and the technical concept disclosed in this specification is not limited by the accompanying drawings.

A singular representation may include a plural representation, unless the context clearly indicates otherwise.

In addition, the terms including an ordinal number such as first, second, and the like as used in this specification may be used to describe various elements, but the elements must not be limited by those terms. The terms are used merely for the purpose to distinguish an element from another element. For example, a first element may be named to a second element, and similarly, a second element may be named to a first element without departing from the scope of right of the invention.

In the following, a speaker device according to an exemplary embodiment of the present disclosure will be described.

Hereinafter, a speaker device according to an exemplary embodiment of the present disclosure may be briefly referred to as a “speaker device of the present disclosure.”

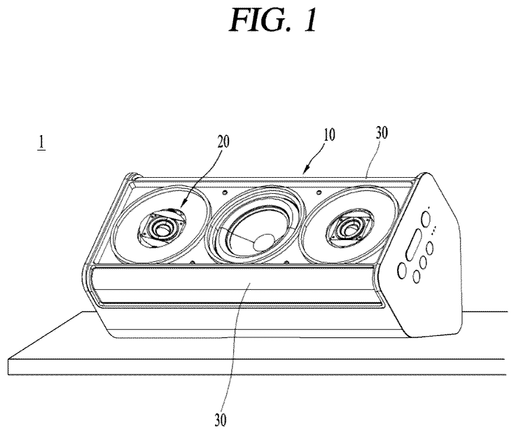

FIGS. 1 to 11, a speaker device 1 of the present disclosure represents an audio device including one or more speakers.

The speaker device 1 of the present disclosure includes a device housing 10 and a speaker assembly 20.

The device housing 10 constitutes an exterior of the speaker device 1, and may be referred to as a “case.”

The device housing 10 is disposed such that a length in one direction (e.g., horizontal direction) is greater than that in another direction (e.g., vertical direction).

The speaker device 1 (specifically, the device housing 10) may be mounted (or placed) horizontally or vertically.

The device housing 10 being mounted (or disposed) horizontally represents that, for example, when the speaker device 1 is placed on a desk, the speaker device 1 is placed such that one direction of the device housing 10 is disposed in parallel to a horizontal direction (see FIG. 1).

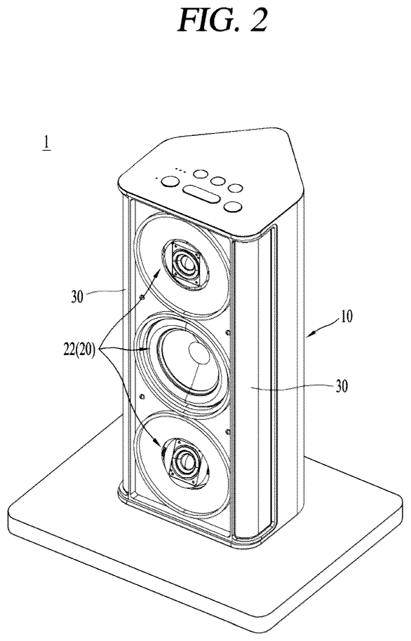

Furthermore, the device housing 10 being mounted (or disposed) vertically represents that, for example, when the speaker device 1 is placed on a desk, the speaker device 1 is placed such that one direction of the device housing 10 is disposed in parallel to a vertical direction (see FIG. 2).

In this specification, a case where the speaker device 1 is mounted (or placed) horizontally may be referred to as ‘horizontal mounting of the speaker device 1’, and a case where the speaker device 1 is mounted (or placed) vertically may be referred to as ‘vertical mounting of the speaker device 1’. Here, the speaker device 1 specifically represents the device housing 10.

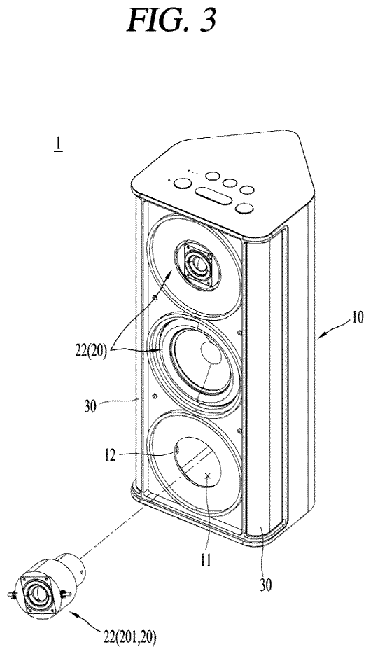

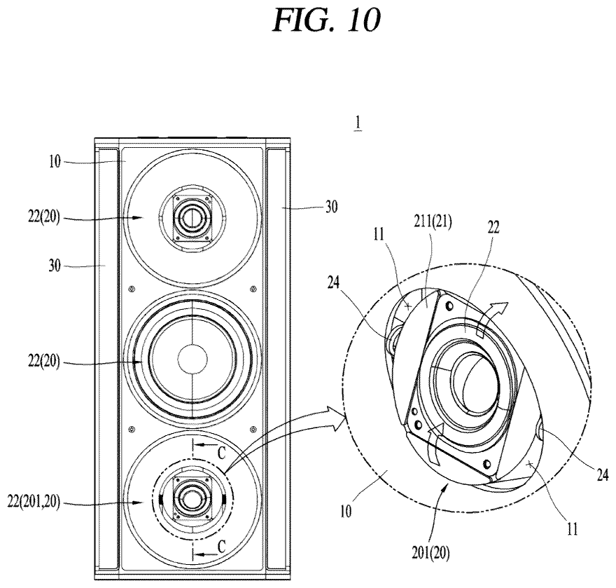

In a case where two or more speaker units 22 are disposed in the speaker device 1 (specifically, device housing 10), when the speaker device 1 is mounted in a vertical direction, the speaker units 22 are disposed in a row in a vertical direction. In this case, at least one speaker unit 22 (e.g., speaker unit 22 disposed at the bottom (see FIGS. 3 and 10)) of the plurality of speaker units 22 may not be directed toward the user's face. In the drawing, reference numeral 201 represents a speaker assembly 201 disposed at the bottom.

For example, when the speaker device 1 is mounted vertically, a radiation angle of the speaker unit 22 disposed at a bottom of the device housing 10 may not be directed toward the user's face.

In order to provide a quality sound to the user, when the speaker device 1 is mounted vertically, the radiation angle of the speaker unit 22 disposed at the bottom needs to be rotated or tilted to be directed toward the user's face.

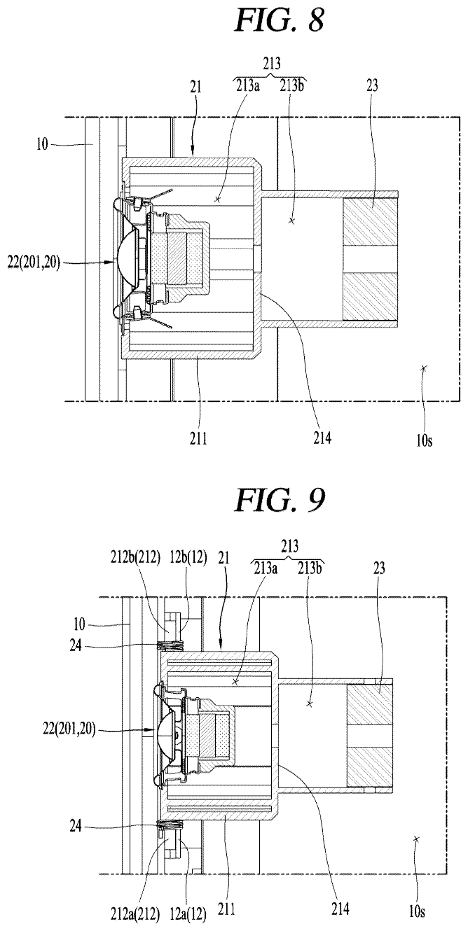

Meanwhile, the device housing 10 has an internal receiving space 10s (see FIG. 8). The speaker assembly 20 and various electrical and electronic devices are received in the receiving space 10s.

The electrical and electronic devices represent various electrical and electronic components that produce sound from the speaker unit 22 of the speaker assembly 20.

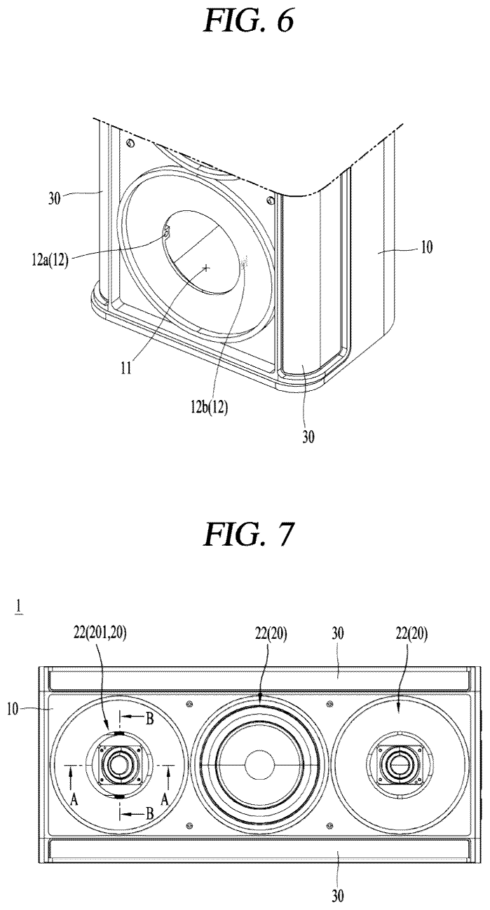

The device housing 10 includes a plurality of opening portions 11 (see FIGS. 3 and 6).

That is, a plurality of opening portions 11 are disposed in the device housing 10.

The speaker assemblies 20 are disposed in the plurality of opening portions 11, respectively.

One surface (e.g., speaker cone) of the speaker unit 22, which is an element of the speaker assembly 20, is exposed to an outside of the device housing 10 through the opening portion 11.

The opening portion 11 may be disposed in a circular or polygonal shape. The shape of the opening portion 11 corresponds to an outer cross-sectional shape of the housing body 211, which will be described later, disposed in the opening portion 11. For example, when the outer cross-sectional shape of the housing body 211 disposed in the opening portion 11 is circular, the opening portion 11 may be disposed in a circular shape. Furthermore, when the outer cross-sectional shape is square, the opening portion 11 may be disposed in a square shape.

An inner surface (or inner peripheral surface) of the device housing 10 surrounding the opening portion 11 and an outer surface (or outer peripheral surface) of the housing body 211 are spaced apart by a preset distance. Accordingly, the housing body 211 may be rotated or tilted in the opening portion 11.

A rotation shaft insertion hole 12 is disposed on the inner surface (or inner peripheral surface) of the device housing 10 surrounding the opening portion 11.

The rotation shaft insertion hole 12 is disposed in a horizontal direction on the inner surface (or inner peripheral surface) of the device housing 10 surrounding the opening portion 11 when the speaker device 1 is mounted in a vertical direction (see FIG. 6).

That is, when the speaker device 1 is mounted in a horizontal direction, the rotation shaft insertion hole 12 is disposed in a vertical direction on the inner surface (or inner peripheral surface) of the device housing 10 surrounding the opening portion 11 (see FIGS. 7 and 9).

The rotation shaft insertion hole 12 is disposed in plurality.

The plurality of rotation shaft insertion holes 12 include a first rotation shaft insertion hole 12a and a second rotation shaft insertion hole 12b (see FIG. 6).

The first rotation shaft insertion hole 12a and the second rotation shaft insertion hole 12b are disposed to face each other on the inner surface (or inner peripheral surface) of the device housing 10 surrounding the opening portion 11.

To elaborate, when the speaker device 1 is mounted in a vertical direction, the first rotation shaft insertion hole 12a and the second rotation shaft insertion hole 12b are disposed on one side and the other side in a horizontal direction, respectively, on the inner surface (or inner peripheral surface) of the device housing 10 surrounding the opening portion 11 to face each other (see FIG. 6).

Accordingly, when the speaker device 1 is mounted in a horizontal direction, the first rotation shaft insertion hole 12a and the second rotation shaft insertion hole 12b are disposed on one side and the other side in a vertical direction, respectively, on the inner surface (or inner peripheral surface) of the device housing 10 surrounding the opening portion 11 to face each other (see FIGS. 7 and 9).

A rotation shaft member 212, which will be described later, is inserted and disposed in the rotation shaft insertion hole 12 (see FIG. 9).

The rotation shaft member 212 is disposed in the rotation shaft insertion hole 12 to be rotatable.

The first rotation shaft member 212a is inserted and disposed in the first rotation shaft insertion hole 12a, and the second rotation shaft member 212b is inserted and disposed in the second rotation shaft insertion hole 12b.

The speaker assembly 20 is disposed in plurality in the device housing 10.

Each of the plurality of speaker assemblies 20 is disposed in each of the plurality of opening portions 11 disposed in the device housing 10.

When the speaker device 1 is mounted in a vertical direction, at least one speaker assembly 20 (e.g., speaker assembly 201 disposed at the bottom) of the plurality of speaker assemblies 20 may be rotated or tilted by a load (see FIGS. 3, 10, and 11).

Accordingly, a radiation angle of the speaker unit 22 in at least one speaker assembly 20 (e.g., speaker assembly 201 disposed at the bottom) of the plurality of speaker assemblies 20 may be rotated or tiled toward the user's face.

In addition, when the speaker device 1 is mounted in a horizontal direction, at least one speaker assembly 20 (e.g., speaker assembly 201 disposed at the bottom) of the plurality of speaker assemblies 20 may return to its original position by an elastic force (restoring force) of an elastic member 24, which will be described later.

Hereinafter, among the plurality of speaker assemblies 20 mounted in the device housing 10, the speaker assembly 201 disposed at the bottom when the speaker device 1 is mounted in a vertical direction will be described in detail.

The speaker assembly 201 disposed at the bottom, which will be described later, may be applied in the same or similar manner to the speaker assembly 20 disposed above the speaker assembly 201 disposed at the bottom.

That is, at least one speaker assembly 20 of the plurality of speaker assemblies 20 may be rotated or tilted by a load when mounted in a vertical direction. Furthermore, the rotated or tilted at least one speaker assembly 20 may return, when mounted in a horizontal direction, to its original position by a restoring force of the elastic member 24.

Hereinafter, the description of the speaker assembly 201 disposed at the bottom may be applied to all speaker assemblies 20 to be rotated or tilted when mounted in a vertical direction and returned to their original positions when mounted in a horizontal direction.

The speaker assembly 20 includes a speaker housing 21, a speaker unit 22, a mass member 23, and an elastic member 24.

The speaker housing 21 constitutes an exterior of the speaker assembly 20.

The speaker housing 21 accommodates the speaker unit 22 and the mass member 23.

The speaker housing 21 is disposed to be long in one direction.

The speaker housing 21 may represent a housing body 211, which will be described later.

The speaker housing 21 (or housing body 211) may be rotated or tilted in one rotation direction.

The speaker housing 21 includes a housing body 211, a receiving portion 213, and a rotation shaft member 212.

The housing body 211 constitutes a body of the speaker housing 21.

The housing body 211 may be disposed in a cylindrical shape having a preset length in one direction. The cylindrical shape is merely one example, and the housing body 211 may also disposed in a polygonal cylindrical shape, or the like. The one direction may represent a length direction of the housing body 211.

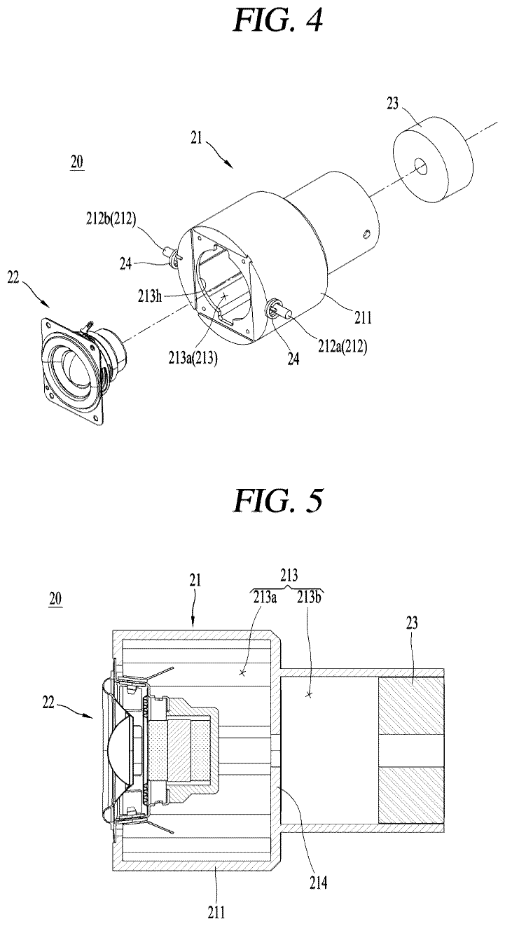

The receiving portion 213 is disposed inside the housing body 211 (see FIGS. 4 and 5).

The receiving portion 213 represents a preset size of space.

The receiving portion 213 includes a first receiving portion 213a and a second receiving portion 213b.

The first receiving portion 213a and the second receiving portion 213b are disposed in one direction of the housing body 211.

The first receiving portion 213a is disposed on one side of the housing body 211 in one direction, and the second receiving portion 213b is disposed on the other side of the housing body 211 in the one direction.

The housing body 211 may include an internal partition wall 214.

The first receiving portion 213a and the second receiving portion 213b may be partitioned (divided) by an internal partition wall 214 (see FIG. 5).

The internal partition wall 214 is disposed inside the housing body 211, and disposed between the first receiving portion 213a and the second receiving portion 213b.

According to an exemplary embodiment of the present disclosure, a preset size of hole (no reference numeral) may be disposed in the internal partition wall 214, or the internal partition wall 214 may not be provided. Electrical wires, and the like may be disposed in the hole. In an exemplary embodiment without having the internal partition wall 214, the first receiving portion 213a and the second receiving portion 213b may communicate with each other.

The internal partition wall 214 includes one side and the other side that are opposite to each other. One side of the internal partition wall 214 faces the first receiving portion 213a, and the other side of the internal partition wall 214 faces the second receiving portion 213b.

One side of the first receiving portion 213a has an opening 213h (see FIG. 4), and one side of the internal partition wall 214 is disposed on the other side of the first receiving portion 213a. Furthermore, the other side of the internal partition wall 214 may be disposed on one side of the second receiving portion 213b, and the other side of the second receiving portion 213b may be open.

The first receiving portion 213a accommodates the speaker unit 22, and the second receiving portion 213b accommodates the mass member 23. The first receiving portion 213a may be named a “speaker unit receiving portion,” and the second receiving portion 213b may be named a “mass member receiving portion.”

The speaker unit 22 is disposed on one side of the first receiving portion 213a, and the mass member 23 is disposed on the other side of the second receiving portion 213b. Accordingly, the speaker unit 22 and the mass member 23 are spaced apart by a preset distance.

The rotation shaft member 212 is disposed outside the housing body 211 (see FIG. 4).

The rotation shaft member 212 is disposed on a side of the first receiving portion 213a.

Specifically, the rotation shaft member 212 is disposed on one side of the housing body 211 in one direction, and disposed on an outer surface of the housing body 211. The rotation shaft member 212 is disposed on an outer surface of the housing body 211 configured with the first receiving portion 213a.

The rotation shaft member 212 is disposed to protrude from an outer surface of the housing body 211 in a direction perpendicular to the outer surface.

To elaborate, the rotation shaft member 212 is disposed to protrude from an outer surface of the housing body 211 in a direction perpendicular to one direction of the housing body 211.

The rotation shaft member 212 is disposed to have a preset length.

The rotation shaft member 212 is disposed in plurality.

The plurality of rotation shaft members 212 includes a first rotation shaft member 212a and a second rotation shaft member 212b.

The first rotation shaft member 212a and the second rotation shaft member 212b are disposed on opposite sides to each other on the outer surface of the housing body 211.

To elaborate, the first rotation shaft member 212a and the second rotation shaft member 212b are disposed to protrude toward opposite sides to each other from the outer surface of the housing body 211.

The rotation shaft member 212 is disposed in the rotation shaft insertion hole 12 disposed in the device housing 10 to rotate.

The first rotation shaft member 212a is disposed in the first rotation shaft insertion hole 12a, and the second rotation shaft member 212b is disposed in the second rotation shaft insertion hole 12b (see FIG. 9).

The speaker unit 22 is disposed in the first receiving portion 213a (speaker unit receiving portion) of the housing body 211 (see FIGS. 4 and 5).

The speaker unit 22 refers to a device that converts electro-acoustic signals into sound waves.

The speaker unit 22 represents a typical speaker, and sound is transmitted to the outside through a speaker cone provided in the speaker unit 22. The speaker unit 22 includes electrical and electronic devices that allow sound to be output through the speaker unit 22. The speaker unit 22 is a publicly known element, and thus a detailed description thereof will be omitted.

The speaker unit 22 may be a tweeter speaker, a mid-range speaker, or a woofer or mid-woofer.

The plurality of speaker assemblies 20 (specifically, speaker unit 22) may include one or more of a tweeter speaker, a mid-range speaker, and/or a woofer speaker.

When the speaker device 1 is mounted in a vertical direction, the speaker unit 22 in the speaker assembly 201 of the plurality of speaker assemblies 20, which is disposed at the bottom, may be a tweeter speaker.

The mass member 23 is disposed in the second receiving portion 213b (mass member receiving portion) of the housing body 211 (see FIGS. 4 and 5).

The mass member 23 has a weight greater than that of the speaker unit 22. That is, the weight of the mass member 23 is heavier than that of the speaker unit 22.

Accordingly, the housing body 211 may be rotated or tilted in one rotation direction due to the weight of the mass member 23.

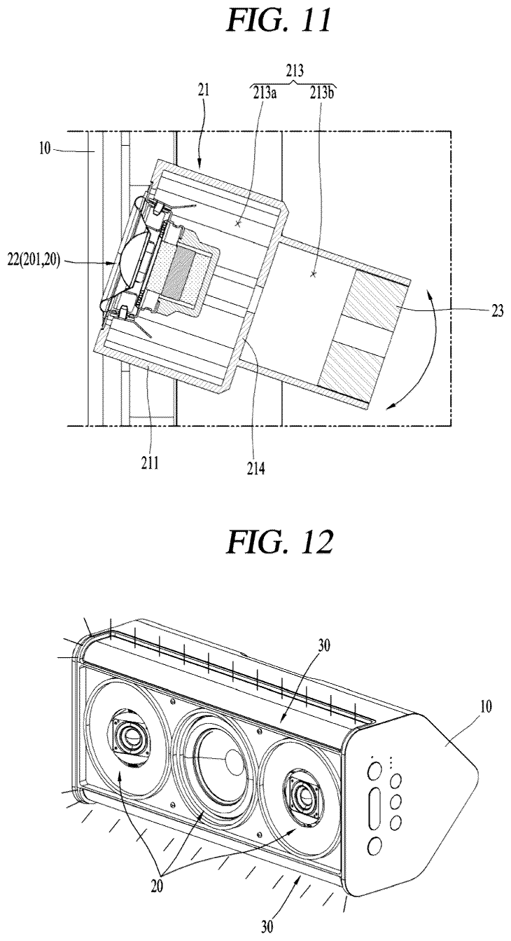

Specifically, since the speaker unit 22 is disposed on one side in one direction of the housing body 211 and the mass member 23 is disposed on the other side in the one direction of the housing body 211, when the speaker device 1 is mounted in a vertical direction, the speaker assembly 20 (specifically, speaker housing 21 or housing body 211) may be rotated or tilted in one rotational direction with the rotation axis member 212 as a rotation axis. At this time, the mass member 23 moves down and the speaker unit 22 moves up (see FIGS. 10 and 11).

As a result, the speaker unit 22 disposed at the bottom is rotated or tilted to be directed toward the user's face.

The elastic member 24 may be a coiled spring. Specifically, the elastic member 24 may be a torsion spring.

The elastic member 24 is disposed on the rotation shaft member 212 (see FIG. 4). The rotation shaft member 212 is inserted into a through hole of the elastic member 24. The through hole of the elastic member 24 represents a hole passing through an inside of the elastic member 24 in a length direction.

The elastic member 24 is disposed on the first rotation shaft member 212a and the second rotation shaft member 212b, respectively.

One end portion of the elastic member 24 is fixed to the housing body 211 or the rotation shaft member 212 of the speaker housing 21. Furthermore, the other end portion of the elastic member 24 is fixed to the rotation shaft insertion hole 12 of the device housing 10 or the inner surface (or inner peripheral surface) of the device housing 10 surrounding the opening portion 11 of the device housing 10.

When the speaker device 1 is mounted in a vertical direction, the first rotation shaft member 212a and the second rotation shaft member 212b are disposed on one side and the other side in a horizontal direction, respectively, on the inner surface (or inner peripheral surface) of the device housing 10 surrounding the opening portion 11 of the device housing 10.

Therefore, due to the weight of the mass member 23, the speaker assembly 20 (specifically, speaker housing 21 or housing body 211) is rotated or tilted in one rotation direction with the rotation shaft member 212 as a rotation axis. At this time, the mass member 23 moves down, and the elastic member 24 has a restoring force to return the speaker assembly 20 to its original position.

When the speaker device 1 is mounted in a horizontal direction, the first rotation shaft member 212a and the second rotation shaft member 212b are disposed on one side and the other side in a vertical direction, respectively, on the inner surface (or inner peripheral surface) of the device housing 10 surrounding the opening portion 11 of the device housing 10 (see FIGS. 7 and 9).

Therefore, since the load of the mass member 23 is not applied downward, the speaker assembly 20 (specifically, speaker housing 21 or housing body 211) is rotated in an opposite direction to one rotation direction by the rotation shaft member as a rotation axis to return to its original position.

Meanwhile, referring to FIGS. 1, 2, 12, and 13, the speaker device 1 of the present disclosure includes a light assembly 30.

The light assembly 30 may emit light.

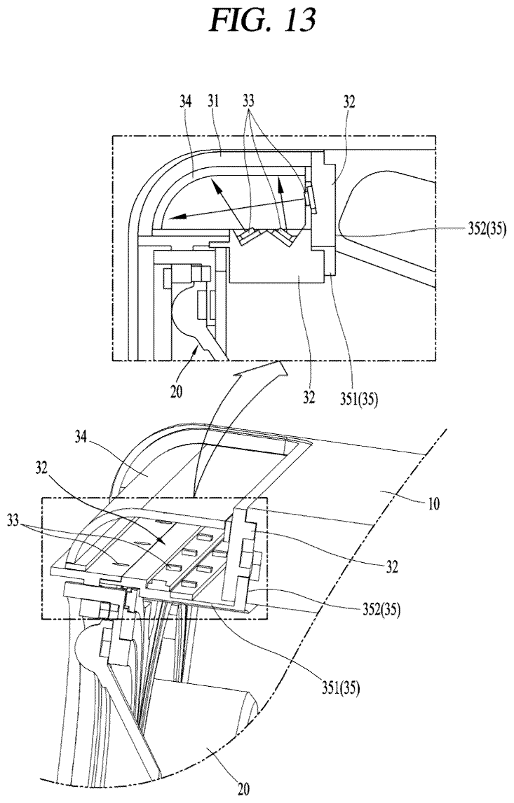

The speaker device 1 (specifically, device housing 10) of the present disclosure includes a light receiving portion 35 (see FIG. 13).

The light assembly 30 is disposed in the light receiving portion 35.

One or more light receiving portions 35 may be disposed in the speaker device 1 (specifically, device housing 10).

The light receiving portion 35 may be disposed in a recess shape at one edge and/or the other edge of the device housing 10. The one edge represents an edge portion where a front surface and one side surface of the device housing 10 are connected to each other, and the other edge represents an edge portion where the front surface and the other side surface of the device housing 10 are connected to each other. The one side and the other side surfaces represent surfaces facing opposite directions to each other.

The light receiving portion 35 is disposed in a length direction of the device housing 10.

The light receiving portion 35 includes a bottom surface 351 and a side surface 352 connected to the bottom surface 351 (see FIG. 13).

One or more light assemblies 30 may be disposed in the speaker device 1 of the present disclosure.

When one light assembly 30 is disposed in the speaker device 1 of the present disclosure, the light assembly 30 may be disposed in the light receiving portion 35 disposed at one edge of the device housing 10.

When two light assemblies 30 are disposed in the speaker device 1 of the present disclosure, the light assemblies 30 may be disposed in the light receiving portions 35 disposed at one edge and the other edge of the device housing 10, respectively.

The light assembly 30 has a preset length in one direction (a length direction) of the device housing 10.

A length of the light assembly 30 in one direction may be equal to that of one edge or the other edge of the device housing 10 in the one direction.

Alternatively, the length of the light assembly 30 in one direction may be equal to that of the light receiving portion 35 in the one direction.

The light assembly 30 includes a cover member 31, a diffusion member 34, a substrate member 32, and a light emitting diode (LED) member 33.

The cover member 31 serves as a cover for the light assembly 30.

The cover member 31 allows light generated from the light emitting diode member 33 to pass therethrough.

The cover member 31 may be formed of various materials that allow light to pass therethrough.

The cover member 31 may be disposed to have a circular or oval cross section so as to cover one edge or the other edge of the speaker device 1 (specifically, device housing 10) of the present disclosure.

One side of the cover member 31 may be connected to an outer edge of the bottom surface 351 of the light receiving portion 35, and the other side of the covering member 31 may be connected to an outer edge of the side surface 352 of the light receiving portion 35.

The light assembly 30 shown below in FIG. 13 is in a state in which the cover member 31 is removed therefrom to reveal the diffusion member 34.

The diffusion member 34 is disposed on an inner surface of the cover member 31.

The diffusion member 34 diffuses light generated from the light emitting diode member 33.

The diffusion member 34 may be disposed in a shape corresponding to that of the cover member 31. That is, the diffusion member 34 may be disposed to have a circular or oval cross section.

One side of the diffusion member 34 may be connected to an outer edge of the bottom surface 351 of the light receiving portion 35, and the other side of the diffusion member 34 may be connected to an outer edge of the side surface 352 of the light receiving portion 35.

The light emitting diode member 33 is a semiconductor element that emits light.

The light emitting diode member 33 is a commonly used LED.

The light emitting diode member 33 may be disposed on the substrate member 32 at a preset angle. This ensures that a uniform amount of light is transmitted to the diffusion member 34.

The light emitting diode member 33 may be disposed in plurality on the substrate member 32.

A plurality of light emitting diode members 33 may be disposed in an array. The array represents a plurality of light emitting diode members 33 being disposed in one direction and at preset intervals.

A plurality of arrays may be disposed on the substrate member 32.

The plurality of arrays may be disposed at different heights or at different preset angles on the substrate member 32.

The substrate member 32 represents a printed circuit board (PCB) on which various electrical and electronic components such as semiconductors, capacitors, and resistors are mounted and the components are electrically connected to one another.

The light emitting diode member 33 is disposed on the substrate member 32.

The substrate member 32 is disposed on the bottom surface 351 and the side surface 352 of the light receiving portion 35.

The bottom surface 351 and/or the side surface 352 of the light receiving portion 35 may be disposed at different heights or at different preset angles for each region. Accordingly, the substrate member 32 and the array disposed on the bottom surface 351 and the side surface 352 of the light receiving portion 35 may be disposed at different heights or at different preset angles for each region.

Alternatively, one surface of the substrate member 32 may be disposed at a different height or at a different preset angle for each region. Accordingly, the light emitting diode member 33 and/or the array disposed on one surface of the substrate member 32 may be disposed at different heights or at different preset angles for each region.

As a result, light generated from the light emitting diode member 33 may be uniformly transmitted to the diffusion member 34.

As described above, a speaker device according to an exemplary embodiment of the present disclosure may allow, when mounted in a vertical direction, at least one speaker unit (e.g., a speaker unit located at the bottom) of a plurality of speaker units to be tilted toward a user's face due to a weight of the mass member without a separate actuator and an external force from the user.

Furthermore, a speaker device according to an exemplary embodiment of the present disclosure may allow, when mounted in a horizontal direction, a speaker unit that has been tilted when mounted in a vertical direction to return to its original angle without a separate actuator or an external force from the user.

In addition, a speaker device according to an exemplary embodiment of the present disclosure may be provided with a light assembly to transmit a uniform amount of light to a diffusion member using a reflection angle.

What is claimed is:

1. A speaker device that can be mounted in a horizontal or vertical direction, the speaker device comprising:
a device housing a constituting an exterior; and
a plurality of speaker assemblies disposed in the device housing,
wherein when mounted in the vertical direction, at least one speaker assembly of the plurality of speaker assemblies is tilted by a load, and
wherein when mounted in the horizontal direction, the tilted speaker assembly is returned to its original position by a restoring force of an elastic member.

2. The speaker device of claim 1, wherein the device housing comprises a plurality of opening portions,
wherein a plurality of rotation shaft insertion holes are disposed on an inner surface of the device housing surrounding the opening portions,
wherein when mounted in the vertical direction, the plurality of rotation shaft insertion holes are respectively disposed on one side and the other side in a horizontal direction on an inner surface of the device housing surrounding the opening portions, and
wherein a rotation shaft member of the speaker assembly is disposed in the rotation shaft insertion hole.

3. The speaker device of claim 1, wherein the device housing comprises a plurality of opening portions,
wherein a plurality of rotation shaft insertion holes are disposed on an inner surface of the device housing surrounding the opening portions,
wherein when mounted in a horizontal direction, the plurality of rotation shaft insertion holes are respectively disposed on one side and the other side in a vertical direction on an inner surface of the device housing surrounding the opening portions, and
wherein a rotation shaft member of the speaker assembly is disposed in the rotation shaft insertion hole.

4. The speaker device of claim 1, wherein at least one speaker assembly of the plurality of speaker assemblies comprises:
a speaker housing;
a speaker unit accommodated on one side of the speaker housing in one direction; and
a mass member accommodated on the other side of the speaker housing in the one direction and disposed to be spaced apart by a preset distance from the speaker unit in the one direction;
wherein a weight of the mass member is greater than that of the speaker unit.

5. The speaker device of claim 4, wherein the speaker housing comprises:
a housing body;
a first receiving portion disposed in the housing body to receive the speaker unit and a second receiving portion that receives the mass member; and
a plurality of rotation shaft members disposed on an outer surface of the housing body disposed with the first receiving portion.

6. The speaker device of claim 5, wherein when mounted in the vertical direction, the housing body is tilted in one rotation direction with the rotation shaft member as a rotation axis due to a weight of the mass member, such that the mass member moves downward and the speaker unit moves upward.

7. The speaker device of claim 5, wherein at least one speaker assembly of the plurality of speaker assemblies further comprises:
the elastic member disposed on the rotation shaft member, and
wherein the elastic member is a torsion spring.

8. The speaker device of claim 7, wherein the device housing comprises a plurality of opening portions,
wherein a plurality of rotation shaft insertion holes are disposed on an inner surface of the device housing surrounding the opening portions,
wherein one end portion of the elastic member is fixed to the housing body or the rotation shaft member, and
wherein the other end of the elastic member is fixed to the rotation shaft insertion hole or the inner surface of the device housing surrounding the opening portion.

9. The speaker device of claim 1, further comprising:
a light assembly disposed in a light receiving portion of the device housing,
wherein the light receiving portion is disposed in a recess shape at one edge or the other edge of the device housing.

10. The speaker device of claim 9, wherein the light assembly comprises:
a cover member through which light passes;
a diffusion member disposed on an inner surface of the cover member;
a substrate member disposed on bottom and side surfaces of the light receiving portion; and
an LED member disposed on the substrate member.

11. The speaker device of claim 10, wherein the bottom or side surface of the light receiving portion is disposed to have a different height or different preset angle for each region.

12. The speaker device of claim 10, wherein one surface of the substrate member is disposed to have a different height or different preset angle for each region.

13. The speaker device of claim 10, wherein the LED member is disposed to have a different height or different preset angle for each region on one surface of the substrate member.

14. The speaker device of claim 1, wherein at least one speaker assembly of the plurality of speaker assemblies is a speaker assembly disposed at the bottom.
